(19) United States
(12) Patent Application Publication
(10) Pub. No.: US 2007/0280294 A1
(43) Pub. Date: Dec. 6, 2007

(54) Constrained Fidelity Constant Bit Rate Video Encoding Systems and Methods

(75) Inventors: Dan Hunt, Nevada City, CA (US); Neil Brydon, Mountain View, CA (US); Sean T. McCarthy, San Francisco, CA (US)

Correspondence Address: JAMES E. EAKIN, P.O. BOX 1250, MENLO PARK, CA, 94025-4317, US

(73) Assignee: Modulus Video, Inc., Sunnyvale, CA (US)

(21) Appl. No.: 11/756,353

(22) Filed: May 31, 2007

Related U.S. Application Data
(60) Provisional application No. 60/810,223, filed on May 31, 2006.

(51) Int. Cl. H04J 1/00

(52) U.S. Cl. 370/485

(57) ABSTRACT

A CBR/VBR hybrid implementation encoding video streams for conserving bandwidth usage in a channel comprises, in an exemplary arrangement, CBR encoding for frames whose complexity exceeds a threshold, and uses VBR encoding for frames whose complexity is below the threshold. In some embodiments, the threshold can be dynamically adjusted to permit varying amounts of bandwidth reclamation. The complexity can be determined based on a motion estimation analysis or on other indicia such as the level of detail in a frame.

### RELATED APPLICATION

This application claims the benefit of U.S. Provisional Patent Application Ser. No. 60/810,223 filed May 31, 2006, which is incorporated herein by reference in its entirety.

### FIELD OF THE INVENTION

The present invention relates generally to methods, systems and techniques for video encoding, and more particularly relates to advanced video encoding using constant bit rate.

### BACKGROUND OF THE INVENTION

Prior art video encoders are designed to operate in one of two distinct ways: variable bit rate mode (VBR) or constant bit rate mode (CBR) mode. In basic terms, a CBR stream is created by adapting or varying the quantization parameters to produce a constant bit rate. With VBR mode, the quantization parameters are nearly static to produce a variable rate stream. DVDs, for instance, are encoded using VBR mode and produce very consistent quality. The fundamental principle is that simple scenes require less bandwidth than scenes with a lot of motion and detail.

In an ideal world, without bandwidth constraints, VBR would universally be used. However, most applications have bandwidth constraints and, therefore, they do not have the luxury of being able to support VBR. These applications require rate control mechanisms that constrain the bit rate within a predefined setting. Various methods such as statistical multiplexing have been developed to allow multiple VBR services to be delivered over a fixed channel by ensuring that the combined bit rate from the encoders does not exceed the bandwidth available from a channel of a fixed size, or, stated differently, does not over subscribe the fixed channel size. However, in a switched broadcast application such as IPTV, services are delivered to a home on an individual basis and statistical multiplexing (statmux) is not an option.

### SUMMARY OF THE INVENTION

The present invention provides a CBR/VBR hybrid implementation for encoding video data streams that can be thought of as Constrained Fidelity CBR. The invention identifies low complexity content which requires less bandwidth to encode with acceptable quality, and reduces below the maximum bandwidth accordingly. This frees additional bandwidth to the channel for use by other services.

The invention may be better appreciated from the following Detailed Description taken in conjunction with the appended Figures.

### THE FIGURES

FIG. 1 shows in system block diagram form several aspects of an embodiment of a system in accordance with the invention.

FIG. 2 shows in flow diagram form several aspects of a process in accordance with the invention.

### DETAILED DESCRIPTION OF THE INVENTION

The present invention is a CBR/VBR hybrid implementation which may be thought of as Constrained fidelity CBR. The present invention may be described, generally, as CBR that will not encode video with more bits than it needs (or constrained fidelity CBR). Alternatively, in at least some implementations, the present invention may also be thought of as VBR with a cap (or capped VBR.)

The present invention delivers to the IPTV environment at least some of the benefits of a statmux solution. CF-CBR allows the video rate to be reduced during less complex sections of video, thereby freeing up bandwidth for data services which must co-exist on the channel to provide acceptable performance. Unlike conventional network constraints which are designed to ensure that the combined bit rates of the UDP/IP video services never exceed a fixed amount, one aspect of the present invention is to identify low complexity content which is comparatively easy to encode and therefore requires less bandwidth to provide acceptable quality. When such content is found, the bit rate will drop below its maximum rate, freeing additional capacity, or bandwidth, in the channel that can be used to augment TCP/IP data services. In this manner, additional bandwidth can be provided for video services, while maintaining at least nominal bandwidth for traditional TCP/IP services. In at least some implementations, bandwidth reclamation on the order of 20% or greater is possible with no perceived drop in the quality of the video service.

The CF-CBR system of the present invention is effectively a hybrid implementation. The system behaves as a fixed quantitative implementation until it hits the CBR max rate. In a first implementation, the CF-CBR control parameters include a maximum bit rate and a bandwidth reclamation strength. The maximum bit rate establishes the a bit rate that is not be exceeded, even for complex scenes such as those with substantial motion. Bandwidth reclamation strength is a factor related to how aggressively bandwidth is to be reclaimed, such that when the CBR stream of the present invention reaches a certain threshold the system will produce a variable bit rate transport stream output. The bandwidth reclamation strength may be configured in any of a variety of ways, including sliding scale, fixed increment, or any other suitable approach. In one implementation, the bandwidth reclamation strength can be a pull-down menu of five increments, for example.

In addition, for at least some embodiments, the ability to enable null packets may be included for, for example, applications that want to fix the bit rate at one point in the network so that bandwidth reclamation can be performed in downstream devices.

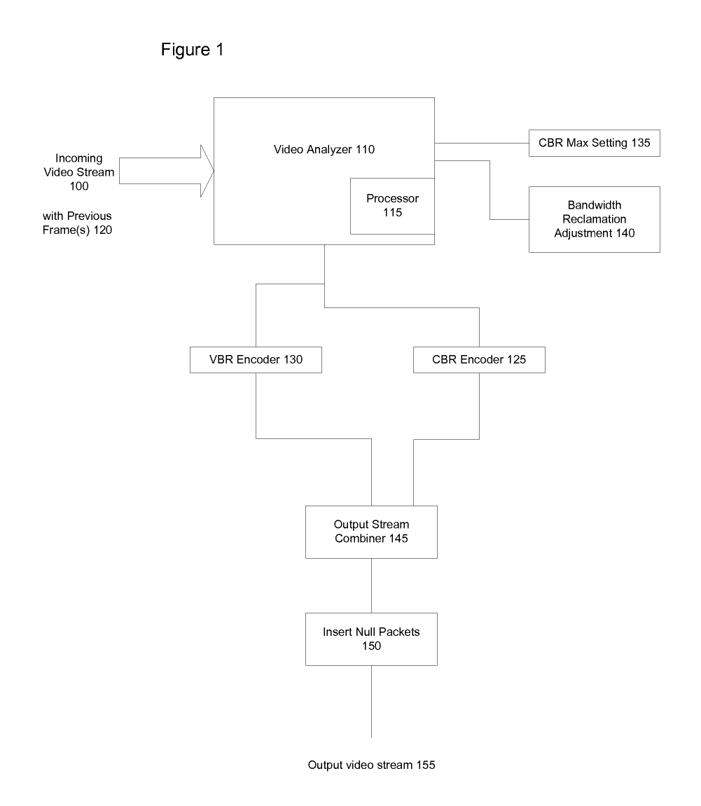

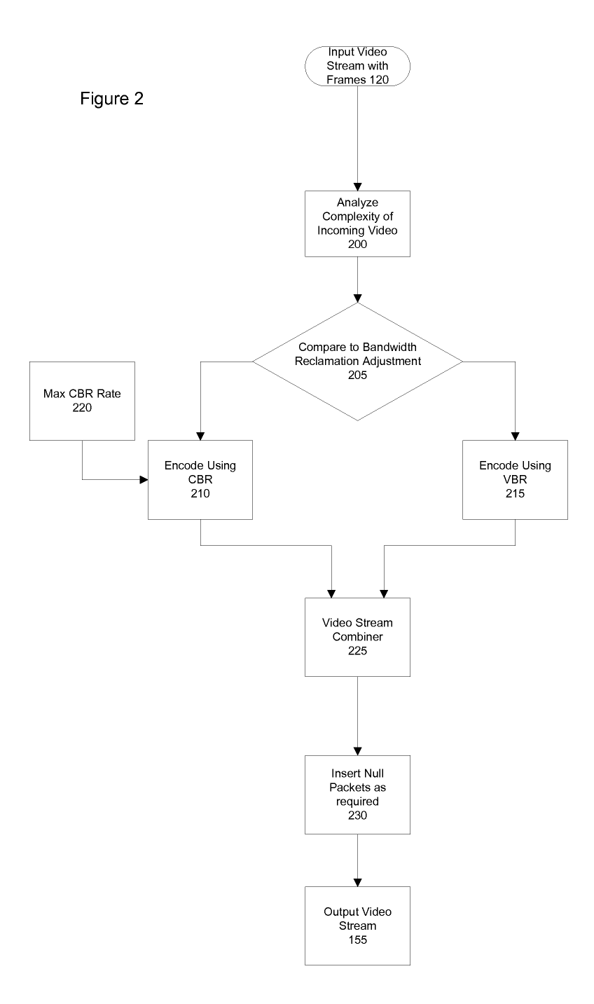

Referring now to FIGS. 1 and 2, which depict the system and process flow, respectively, of an embodiment of the invention, an incoming video stream 100 is supplied to a video analyzer 110. The incoming video stream typically includes a series of video frames, or images. The video analyzer 110 typically includes a processor 115 executing a motion estimation algorithm to determine, among other things, the complexity of the incoming video stream 100. The complexity of the video stream can also be based on other indicia, such as the level of detail in a particular frame.

The video analyzer 110 makes a determination concerning the complexity of a video frame relative to a prior frame or frames 120 and, if the complexity is above a preset threshold, the frame is encoded by use of a CBR encoder 125, which can be an encoding process that operates using the same processor 115 or a different processor. These process steps are shown at 200, 205 and 210 in FIG. 2. However, if the frame is of relatively low complexity relative to the prior frame or frames, such that a CBR technique would use more bandwidth than required, the frame is encoded by use of a VBR encoder 130, shown in FIG. 2 at step 215. As with the CBR encoder 125, the VBR encoder 130 may be a process operating in conjunction with the processor 115 or with a different processor.

It will also be appreciated that the maximum bit rate of those frames encoded by the CBR encoder 125 may be preset by means of a CBR maximum setting 135 associated with the CBR encoder 125, shown at 220 in FIG. 2. Further, a bandwidth reclamation adjustment 140 can be associated with the video analyzer 110 for setting the threshold for determining whether a frame is complex or not. It will be appreciated that, when the video analyzer 110 determines that the complexity of a frame exceeds the threshold set by the bandwidth reclamation adjustment 140, the frame is again encoded by the CBR encoder 125. In this manner a video sequence can be encoded using the VBR technique where this will result in a savings of bandwidth, and the CBR technique where the VBR technique would yield too high a use of bandwidth. The encoded frames are then combined in a combiner 145 (step 225 in FIG. 2) and null packets may be added as shown at 150 (step 230 in FIG. 2), to yield an encoded video output sequence 155. The combiner 145 can be a process operating in the processor 115 or a different processor, or can be a hardware combiner.

Having fully described an implementation of the invention, it will be appreciated by those skilled in the art that the foregoing description is exemplary and not limiting and that numerous alternatives exist which do not depart from the invention. As a result, the invention is not to be limited by the foregoing description, but only by the appended claims.

We claim:

1. A method of encoding video data streams including a plurality of sequential frames comprising the steps of
determining the complexity of a frame relative to at least one prior frame,
comparing the complexity to a threshold,
encoding the frame using a constant bit rate if the complexity of the frame exceeds the threshold, and
encoding the frame using a variable bit rate if the complexity of the frame is below the threshold.

2. The method of claim 1 further comprising the step of dynamically adjusting the threshold to reclaim bandwidth based on system conditions.

3. The method of claim 1 further comprising the step of combining all of the encoded frames into an output stream.

4. The method of claim 1 further comprising the step of adding null packets.

5. The method of claim 1 wherein the determining step comprises the use of a motion estimation algorithm.

6. The method of claim 1 wherein the determining step comprises an analysis of a level of detail in the frame.

7. A system for encoding video data streams including a plurality of sequential frames comprising
a video analyzer which determines the complexity of a video frame in comparison with at least one prior frame,
a first encoder for encoding the frame with a first algorithm if the frame exceeds a threshold based on the determination made by the video analyzer,
a second encoder for encoding the frame with a second algorithm if the frame is below the threshold, and
a combiner for combining the encoded frames to provide an output video stream.

8. The system of claim 7 in which the video analyzer, encoders and combiner are logic functions performed by one or more processors.

9. A computer readable media having recorded thereon a series of program instructions for causing a computer to perform steps comprising
determining the complexity of a frame relative to at least one prior frame,
comparing the complexity to a threshold,
encoding the frame using a constant bit rate if the complexity of the frame exceeds the threshold, and
encoding the frame using a variable bit rate if the complexity of the frame is below the threshold.
